(19) United States
(12) Patent Application Publication
(10) Pub. No.: US 2026/0052311 A1
(43) Pub. Date: Feb. 19, 2026

(54) ADJUSTABLE MONITORING DEVICE AND ELECTRONIC ASSEMBLY

(71) Applicant: WISTRON CORP., New Taipei City (TW)

(72) Inventor: Pei Hsin HUANG, New Taipei City (TW)

(21) Appl. No.: 18/947,074

(22) Filed: Nov. 14, 2024

(30) Foreign Application Priority Data
Aug. 16, 2024 (TW) 113130888

(51) Int. Cl. H04N 23/695; H04N 23/54; H04N 23/56

(52) U.S. Cl. CPC H04N 23/695; H04N 23/54; H04N 23/56

(57) ABSTRACT

The disclosure provides an adjustable monitoring device and an electronic assembly. The adjustable monitoring device includes an adjusting assembly and an image capturing assembly. The adjusting assembly includes a fixed bracket, a first movable bracket and a second movable bracket. The first movable bracket and the second movable bracket are movably disposed on the fixed bracket, and the second movable bracket is spaced apart from the first movable bracket. The image capturing assembly is connected to the adjusting assembly. An image monitoring direction of the image capturing assembly is adjustable by the adjusting assembly.

### CROSS-REFERENCE TO RELATED APPLICATIONS

This non-provisional application claims priority under 35 U.S.C. § 119(a) on Patent Application No(s). 113130888 filed in Taiwan, R.O.C. on Aug. 16, 2024, the entire contents of which are hereby incorporated by reference.

### TECHNICAL FIELD

The disclosure relates to an adjustable monitoring device and an electronic assembly, more particularly to an adjustable monitoring device and an electronic assembly including an image capturing assembly.

### BACKGROUND

Recently, with the rapid development of the self-driving technology, not only the environment outside the car is monitored but also the attentiveness of the drive inside the car is monitored. Thus, the Driver Monitoring System (DMS) has become an indispensable system in a self-driving vehicle.

However, the traditional DMS usually adopts a fixed image capturing device, which limits the range for the image capturing device to capture images. Thus, when the driver moves, the image capturing device may be unable to capture images at a desired angle, thereby failing to effectively monitoring the attentiveness of the driver.

### SUMMARY

The disclosure provides an adjustable monitoring device and an electronic assembly including a first movable bracket and a second movable bracket that adjust an image monitoring direction of the image capturing device by swinging relative to a fixed bracket, thereby enlarging the range for the image capturing device to capture images.

One embodiment of this disclosure provides an adjustable monitoring device including an adjusting assembly and an image capturing assembly. The adjusting assembly includes a fixed bracket, a first movable bracket and a second movable bracket. The first movable bracket and the second movable bracket are movably disposed on the fixed bracket, and the second movable bracket is spaced apart from the first movable bracket. The image capturing assembly is connected to the adjusting assembly. An image monitoring direction of the image capturing assembly is adjustable by the adjusting assembly.

Another embodiment of this disclosure provides an electronic assembly including a housing, an image displaying component and an adjustable monitoring device. The image displaying component is disposed in the housing. The adjustable monitoring device is disposed in the housing and includes an adjusting assembly and an image capturing assembly. The adjusting assembly includes a fixed bracket, a first movable bracket and a second movable bracket. The first movable bracket and the second movable bracket are movably disposed on the fixed bracket, and the second movable bracket is spaced apart from the first movable bracket. The image capturing assembly is connected to the adjusting assembly. An image monitoring direction of the image capturing assembly is adjustable by the adjusting assembly.

According to the adjustable monitoring device and the electronic assembly disclosed by above embodiments, the first movable bracket and the second movable bracket are configured to swing relative to the fixed bracket so as to adjust the image monitoring direction of the image capturing assembly. Thus, since the first movable bracket and the second movable bracket are able to swing, the image capturing device is allowed to capture images at different angles. In this way, even though the driver moves, the image monitoring direction of the image capturing device is allowed to be adjusted according to the movement of the driver. Thus, the image capturing device is able to effectively monitor the attentiveness of the driver.

Also, when the adjustable monitoring device is applied to, for example, a car, the image capturing assembly is allowed to capture images at desired angles regardless of the right-hand drive car or the left-hand drive car since the image capturing assembly is able to swing together with the first movable bracket or the second movable bracket. That is, the adjustable monitoring device is allowed to be shared among cars of different types, thereby significantly reducing the cost for developing exclusive monitoring device for a specific type of car.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of an electronic assembly according to a first embodiment of the disclosure;

FIG. 2 is an exploded view of the electronic assembly in FIG. 1;

FIG. 3 is a perspective view of an adjustable monitoring device of the electronic assembly in FIG. 1;

FIG. 4 is a perspective view of the adjustable monitoring device in FIG. 3 in another viewing angle;

FIG. 5 is a bottom view of the adjustable monitoring device in FIG. 3;

FIG. 6 is a bottom view showing that the adjustable monitoring device in FIG. 5 swings;

FIG. 7 is a perspective view of an adjustable monitoring device according to a second embodiment of the disclosure;

FIG. 8 is a bottom view of the adjustable monitoring device in FIG. 7;

FIG. 9 is a bottom view showing that the adjustable monitoring device in FIG. 8 swings;

FIG. 10 is a perspective view of an adjustable monitoring device according to a third embodiment of the disclosure;

FIG. 11 is a bottom view of the adjustable monitoring device in FIG. 10;

FIG. 12 is a bottom view showing that the adjustable monitoring device in FIG. 11 swings;

FIG. 13 is a perspective view showing that a first movable bracket of an adjustable monitoring device of a fourth embodiment of the disclosure swings;

FIG. 14 is a perspective view showing that a second movable bracket of the adjustable monitoring device in FIG. 13 swings;

FIG. 15 is a perspective view of an adjustable monitoring device according to a fifth embodiment of the disclosure;

FIG. 16 is a rear view showing that the adjustable monitoring device in FIG. 15 swings;

FIG. 17 is a partially enlarged perspective view of an adjustable monitoring device according to a sixth embodiment of the disclosure;

FIG. 18 is a rear view showing that the adjustable monitoring device in FIG. 17 swings;

FIG. 19 is a partially enlarged exploded view of an electronic assembly according to a seventh embodiment of the disclosure;

FIG. 20 is a partial exploded view of the electronic assembly in FIG. 19;

FIG. 21 is a perspective view of an adjustable monitoring device of the electronic assembly in FIG. 19;

FIG. 22 is a top view of the adjustable monitoring device in FIG. 21; and

FIG. 23 is a top view showing that the adjustable monitoring device in FIG. 22 swings.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

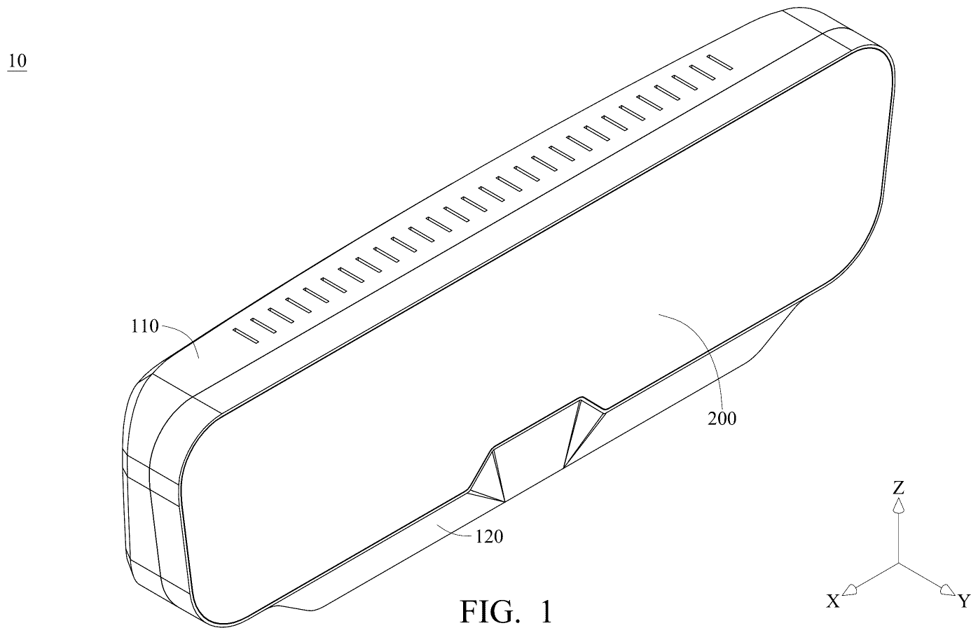

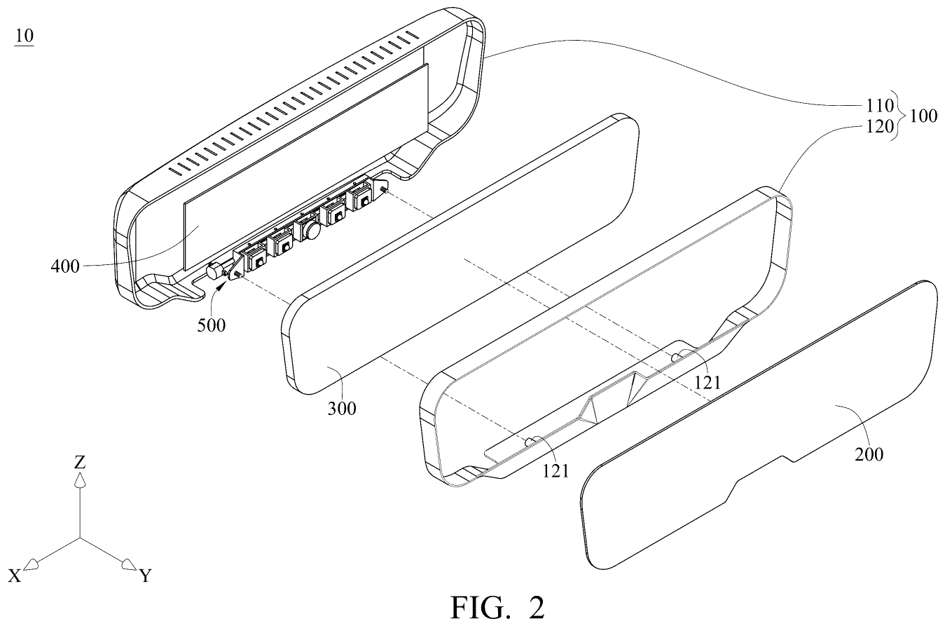

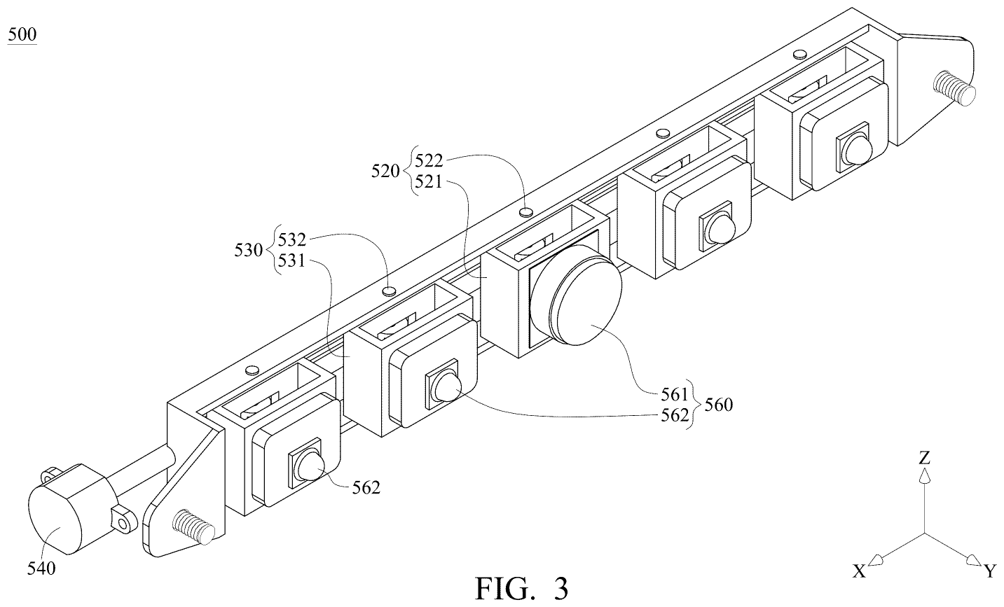

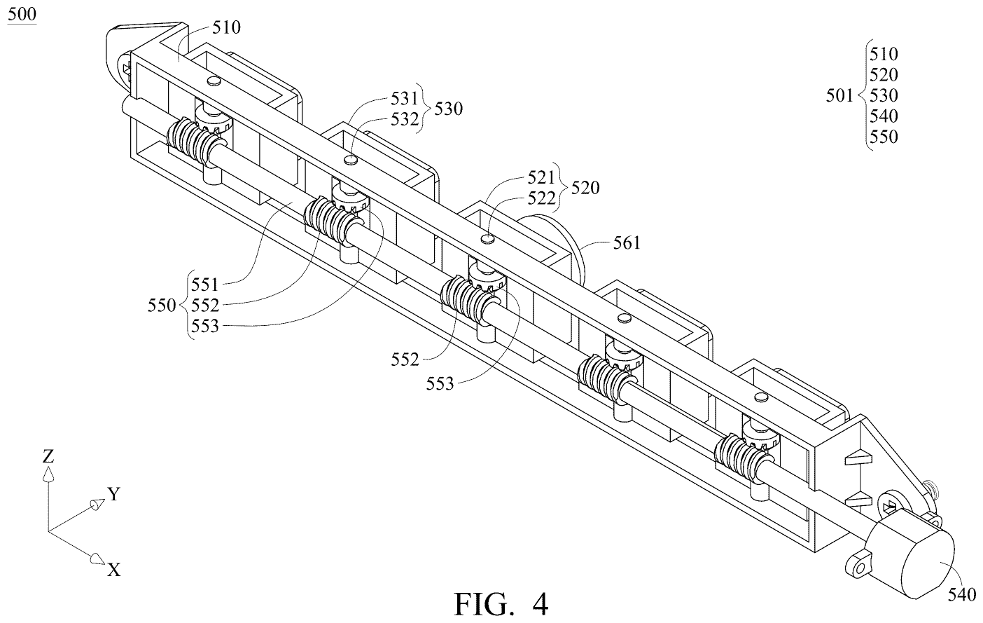

Please refer to FIGS. 1 to 4. FIG. 1 is a perspective view of an electronic assembly 10 according to a first embodiment of the disclosure. FIG. 2 is an exploded view of the electronic assembly 10 in FIG. 1. FIG. 3 is a perspective view of an adjustable monitoring device 500 of the electronic assembly 10 in FIG. 1. FIG. 4 is a perspective view of the adjustable monitoring device 500 in FIG. 3 in another viewing angle.

In this embodiment, the electronic assembly 10 is, for example, a rearview mirror assembly. The electronic assembly 10 includes, for example, a housing 100, a transparent panel 200, an image displaying component 300, a motherboard 400 and the adjustable monitoring device 500. The housing 100 includes, for example, a base 110 and a front frame 120. The front frame 120 is made by, for example, a plastic material. The front frame 120 is disposed on a side of the base 110. The transparent panel 200 is, for example, a glass panel. The transparent panel 200 is disposed in the front frame 120 and is surrounded by the front frame 120.

The image displaying component 300 is disposed in the housing 100. Further, the image displaying component 300 may be disposed between the transparent panel 200 and the base 110. In this embodiment, the electronic assembly 10 is, for example, an electronic rearview mirror. Also, the image displaying component 300 is, for example, a display panel configured to display an image of the rear view of the car. However, the disclosure is not limited thereto. In other embodiments, the image displaying component may be a traditional rearview mirror, and the image displaying component may be a mirror. In other embodiments, the electronic assembly may not include the transparent panel 200.

The motherboard 400 is disposed in the base 110, and is electrically connected to the image displaying component 300 and the adjustable monitoring device 500.

In this embodiment, the adjustable monitoring device 500 is, for example, a Driver Monitoring System (DMS). The adjustable monitoring device 500 is disposed in the housing 100, and includes an adjusting assembly 501 and an image capturing assembly 560. In this embodiment, the adjusting assembly 501 includes a fixed bracket 510, a first movable bracket 520, a plurality of second movable brackets 530, a driving component 540 and a connecting structure 550.

The fixed bracket 510 is fixed to the two fixing pins 121 of the front frame 120 via, for example, screwing. The first movable bracket 520 includes a first mounting part 521 and a first pivot part 522. The first mounting part 521 is fixed to the first pivot part 522. The first pivot part 522 is rotatably disposed on the fixed bracket 510.

Each second movable bracket 530 includes a second mounting part 531 and a second pivot part 532. The second mounting part 531 is fixed to the second pivot part 532. The second pivot part 532 is rotatably disposed on the fixed bracket 510. The first movable bracket 520 is, for example, spaced apart from the second movable brackets 530.

For example, the driving component 540 is a motor and may be electrically connected to the motherboard 400. The connecting structure 550 connects the driving component 540, the first pivot part 522 and the second pivot part 532. In detail, the connecting structure 550 includes, a connecting rod 551, a plurality of first gears 552 and a plurality of second gears 553. The first gears 552 are, for example, helical gears. The first gears 552 are sleeved on the connecting rod 551, and are spaced part from one another. The second gears 553 are, for example, bevel gears. The second gears 553 are sleeved on the first pivot part 522 and the second pivot parts 532, respectively. The second gears 553 are meshed with the first gears 552, respectively. The connecting rod 551 is connected to the driving component 540. Specifically, the connecting rod 551 may be fixed to a shaft (not shown) of the driving component 540 or may be directly driven by the driving component.

In this embodiment, the image capturing assembly 560 may be electrically connected to the motherboard 400, and may include an image capturing device 561 and a plurality of light emitting components 562. The image capturing device 561 is fixed to a side of the first mounting part 521 located away from the first pivot part 522. The light emitting components 562 are, for example, light emitting diodes emitting infrared ray. The light emitting components 562 are fixed to sides of the second mounting parts 531 located away from the second pivot part 532, respectively. In other embodiments, the image capturing assembly may not include the light emitting component 562. Of course, in other embodiments, the numbers of the second movable brackets, the first gears and the second gears may be adjusted according to the number of the light emitting component(s).

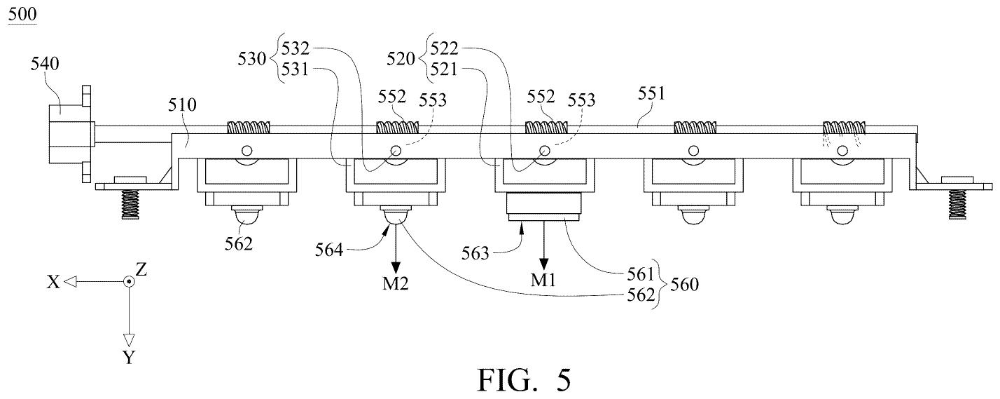

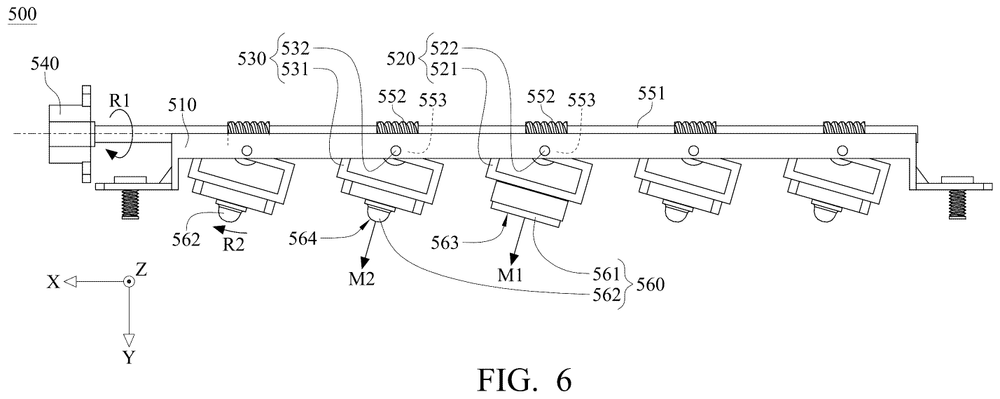

Please refer to FIGS. 5 and 6. FIG. 5 is a bottom view of the adjustable monitoring device 500 in FIG. 3. FIG. 6 is a bottom view showing that the adjustable monitoring device 500 in FIG. 5 swings. As shown in FIG. 5, in this embodiment, the image capturing device 561 has a light receiving surface 563. The normal direction of the light receiving surface 563 denotes an image monitoring direction M1 of the image capturing device 561. In addition, the light emitting component 562 has a light emitting surface 564. The normal direction of the light emitting surface 564 denotes an image monitoring direction M2 of the light emitting component 562. In FIG. 5, the image monitoring directions M1 and M2 are, for example, parallel to the Y-axis direction. Moreover, in this disclosure, the image monitoring direction of the image capturing assembly 560 may refer to the image monitoring direction M1 or the image monitoring direction M2. Furthermore, in this embodiment, the axial direction (i.e., Z-axis direction) of the first pivot part 522 and the second pivot part 532 is, for example, perpendicular to the image monitoring directions M1 and M2. That is, the first pivot part 522 and the second pivot part 532 is this embodiment are configured to allow the first mounting part 521 and the second mounting part 531 to swing leftwards or rightwards along Z-axis, respectively.

Thus, since the first movable bracket 520 and the second movable bracket 530 are able to swing, the image capturing assembly 560 is allowed to capture images at different angles. In this way, even though the driver moves, the image monitoring direction of the image capturing assembly 560 is adjustable by the adjusting assembly 501, for example, according to the movement of the driver. Thus, the image capturing assembly 560 is able to effectively monitor the attentiveness of the driver.

Also, when the adjustable monitoring device 500 is applied to, for example, a car, the image capturing assembly 560 is allowed to capture images at desired angles regardless of the right-hand drive car or the left-hand drive car since the image capturing assembly 560 is able to swing together with the first movable bracket 520 or the second movable bracket 530. That is, the adjustable monitoring device 500 is allowed to be shared among cars of different types, thereby significantly reducing the cost for developing exclusive monitoring device for a specific type of car.

As shown in FIGS. 5 and 6, the driving component 540 is configured to rotate the connecting rod 551 along a rotating direction R1, thereby forcing the first gears 552 to be rotated along the rotating direction R1. Thus, the second gears 553 meshed with the first gears 552 are rotated along a rotating direction R2, thereby forcing the first pivot part 522 and the second pivot parts 532 to be rotated along the rotating direction R2. In this way, the first mounting part 521 and the second mounting parts 531 are rotated along the rotating direction R2 relative to the fixed bracket 510, thereby changing the image monitoring directions M1 and M2 of the image capturing device 561 and the light emitting components 562 from a state of being parallel to Y-axis direction in FIG. 5 to a state of being at an angle to Y-axis direction in FIG. 6. That is, the first mounting part 521 and the second mounting parts 531 are rotated along the rotating direction R2 relative to the fixed bracket 510, thereby forcing the image capturing device 561 and the light emitting components 562 to swing along Z-axis.

Note that the range in which the image capturing device 561 and the light emitting component 562 swings may be adjusted by changing the length of the first gears 552.

With the cooperation of the first gears 552 and the second gears 553, the image capturing device 561 and the light emitting component 562 are allowed to swing in a more reliable and stable manner, thereby prolonging the life span of the adjustable monitoring device 500 and enhancing the reliability thereof.

Other embodiments are described below for illustrative purposes. It is to be noted that the following embodiments use the reference numerals and a part of the contents of the above embodiments, the same reference numerals are used to denote the same or similar elements, and the description of the same technical contents is omitted. For the description of the omitted part, reference may be made to the above embodiments, and details are not described in the following embodiments.

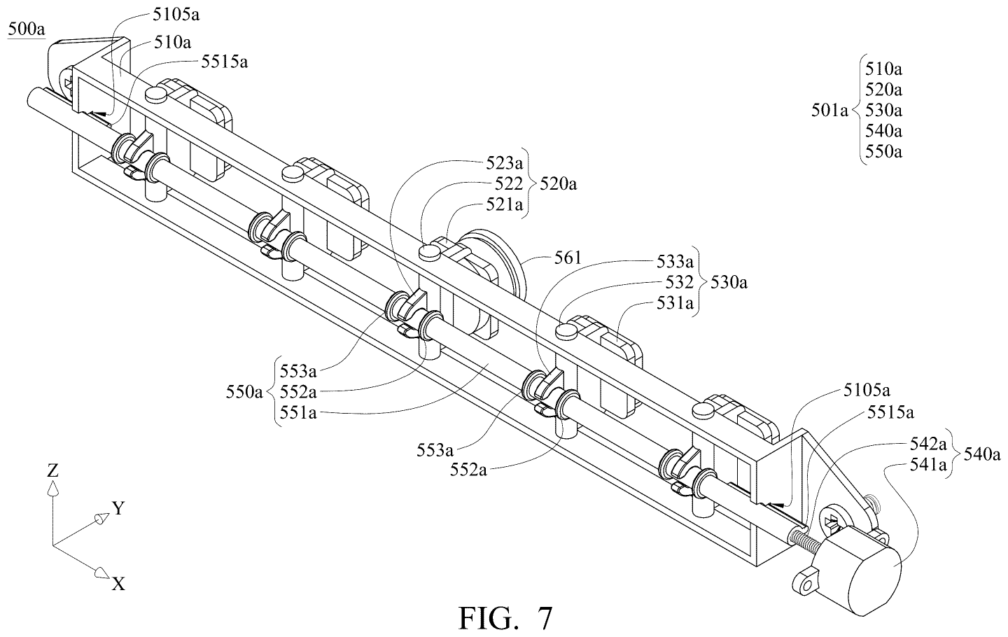

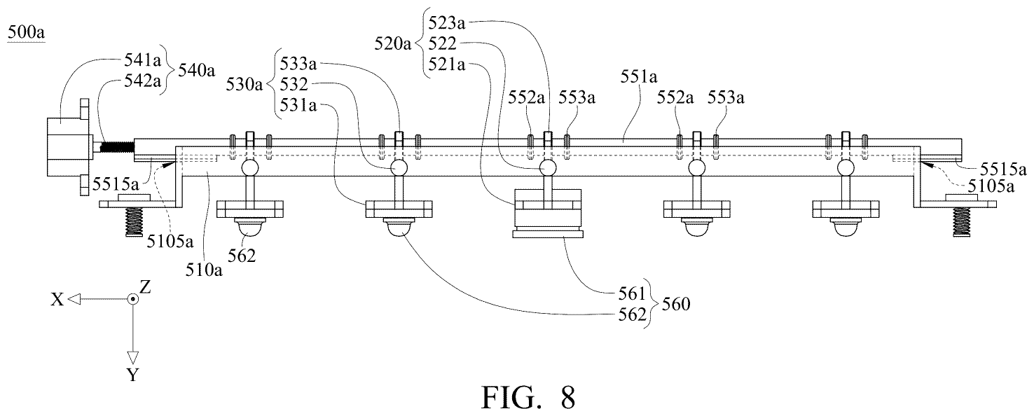

The disclosure is not limited by the structure of the adjusting assembly. Please refer to FIGS. 7 and 8. FIG. 7 is a perspective view of an adjustable monitoring device 500a according to a second embodiment of the disclosure. FIG. 8 is a bottom view of the adjustable monitoring device 500a in FIG. 7. In this embodiment, the adjustable monitoring device 500a includes an adjusting assembly 501a and the image capturing assembly 560. In this embodiment, the adjusting assembly 501a includes a fixed bracket 510a, a first movable bracket 520a, a plurality of second movable brackets 530a, a driving component 540a and a connecting structure 550a.

The first movable bracket 520a includes a first mounting part 521a, a first pivot part 522 and a pushed protrusion 523a. The first mounting part 521a is fixed to the first pivot part 522. The pushed protrusion 523a protrudes from a side of the first pivot part 522 located away from the first mounting part 521a. The first pivot part 522 is rotatably disposed on the fixed bracket 510a.

Each second movable bracket 530a includes a second mounting part 531a, a second pivot part 532 and a pushed protrusion 533a. The second mounting part 531a is fixed to the second pivot part 532. The pushed protrusion 533a protrudes from a side of the second pivot part 532 located away from the second mounting part 531a. The second pivot part 532 is rotatably disposed on the fixed bracket 510a.

For example, the driving component 540a is a motor and includes a main body 541a and a shaft 542a. The shaft 542a has, for example, an outer threaded structure (not labeled). The connecting structure 550a connects the driving component 540, the first pivot part 522 and the second pivot parts 532. In detail, the connecting structure 550a includes, for example, a connecting rod 551a, a plurality of first pushing protrusions 552a and a plurality of second pushing protrusions 553a. The first pushing protrusions 552a and the second pushing protrusions 553a radially protrude from the connecting rod 551a. Each pushed protrusion 523a and 533a is located between one first pushing protrusion 552a and one second pushing protrusion 553a that are located adjacent to each other. The connecting rod 551a has, for example, an inner threaded structure (not shown) mated with the outer threaded structure of the shaft 542a. Further, the connecting rod 551a has, for example, two protrusions 5515a radially protrude outwards therefrom. The two protrusions 5515a are engaged with two recesses 5105a of the fixed bracket 510a, respectively, thereby restricting the rotation of the connecting rod 551a along X-axis direction. In other embodiments, the numbers of the second movable brackets, the first pushing protrusions and the second pushing protrusions may be adjusted according to the number of the light emitting component(s).

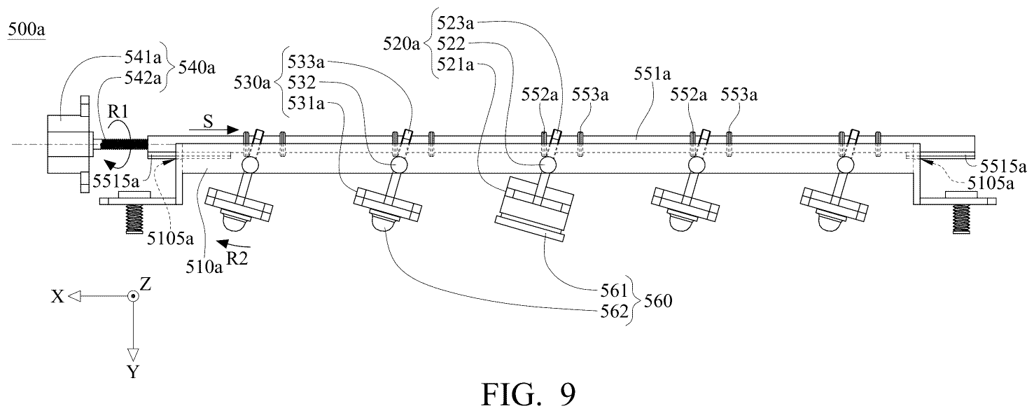

Please refer to FIGS. 8 and 9. FIG. 9 is a bottom view showing that the adjustable monitoring device 500a in FIG. 8 swings. The shaft 542a of the driving component 540a is configured to be rotated along the rotating direction R1. The inner threaded structure of the connecting rod 551a is mated with the outer threaded structure of the shaft 542a, and the two protrusions 5515a are respectively engaged with the two recesses 5105a of the fixed bracket 510a to restrict the rotation of the connecting rod 551a along X-axis direction. Thus, when the shaft 542a is rotated along the rotating direction R1, the connecting rod 551a slides along a sliding direction S so as to force the pushed protrusions 523a and the 533a to be pushed by adjacent first pushing protrusion 552a or adjacent second pushing protrusion 553a. Accordingly, the first pivot part 522 and the second pivot parts 532 are rotated along the rotating direction R2. In this way, the first mounting part 521a and the second mounting parts 531a are rotated along the rotating direction R2 relative to the fixed bracket 510a, thereby allowing the image capturing device 561 and the light emitting components 562 to swing along Z-axis.

Note that the range in which the image capturing device 561 and the light emitting component 562 swings may be adjusted by changing the position of the first pushing protrusions 552a and the position of the second pushing protrusions 553a.

Moreover, the first pushing protrusions 552a and the second pushing protrusions 553a are not limited to being spaced apart from the pushed protrusion 523a. In other embodiments, the first pushing protrusions and the second pushing protrusions may be in contact with the pushed protrusion.

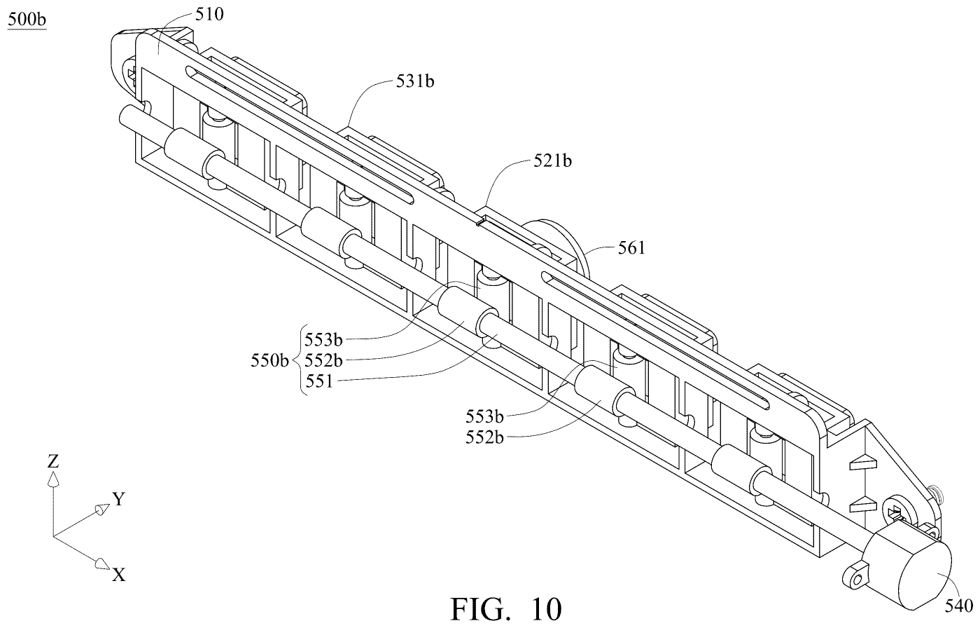

Alternatively, please refer to FIG. 10 that is a perspective view of an adjustable monitoring device 500b according to a third embodiment of the disclosure. In this embodiment, the adjustable monitoring device 500b includes an adjusting assembly 501b and the image capturing assembly 560. In this embodiment, the adjusting assembly 501b includes the fixed bracket 510, a first movable bracket 520b, a plurality of second movable bracket 530b, the driving component 540 and a connecting structure 550b.

The first movable bracket 520b includes a first mounting part 521b and the first pivot part 522. The first mounting part 521b is fixed to the first pivot part 522. The first pivot part 522 is rotatably disposed on the fixed bracket 510.

Each second movable bracket 530b includes a second mounting part 531b and the second pivot part 532. The second mounting part 531b is fixed to the second pivot part 532. The second pivot part 532 is rotatably disposed on the fixed bracket 510.

The connecting structure 550b includes the connecting rod 551, a plurality of first magnetic gears 552b and a plurality of second magnetic gears 553b. The first magnetic gears 552b are sleeved on the connecting rod 551, and are spaced apart from one another. The second magnetic gears 553b are sleeved on the first pivot part 522 and the second pivot parts 532, respectively. The second magnetic gears 553b are located adjacent to the first magnetic gears 552b, respectively. An axial direction (i.e., X-axis direction) of the first magnetic gears 552b and an axial direction (i.e., Z-axis direction) of the second magnetic gears 553b are non-parallel (e.g., perpendicular) to each other. The connecting rod 551 is connected to the driving component 540. In other embodiments, the numbers of the second movable brackets, the first magnetic gears and the second magnetic gears may be adjusted according to the number of the light emitting component(s).

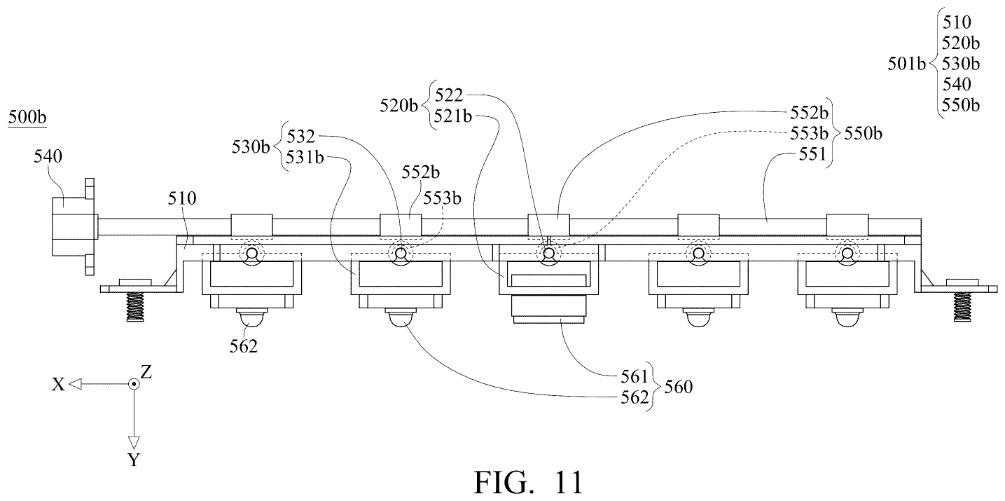

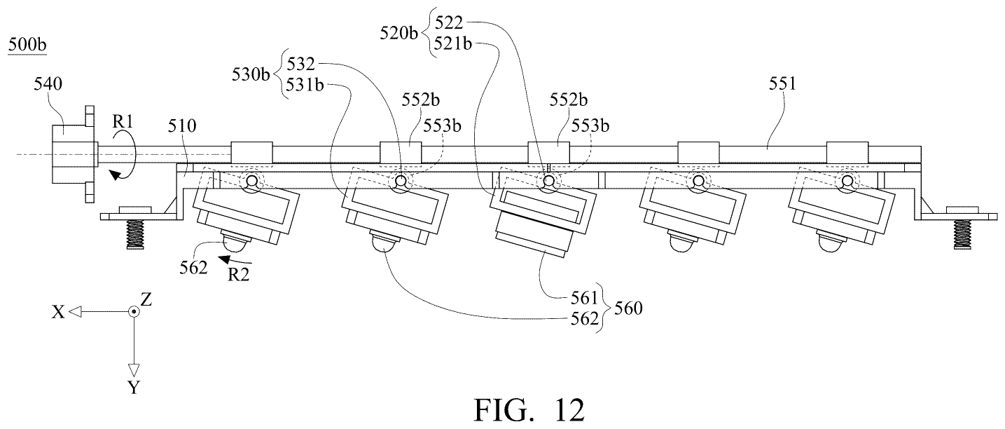

Please refer to FIGS. 11 and 12. FIG. 11 is a bottom view of the adjustable monitoring device 500b in FIG. 10. FIG. 12 is a bottom view showing that the adjustable monitoring device 500b in FIG. 11 swings. The first magnetic gears 552b and the second magnetic gears 553b may be previously magnetized by the current applied thereon, and the first magnetic gears 552b may repel the second magnetic gears 553b. Then, the driving component 540 is configured to rotate the connecting rod 551 along the rotating direction R1, thereby forcing the first magnetic gears 552b to be rotated along the rotating direction R1. Thus, since the magnetic field generated by the first magnetic gear 552b and the second magnetic gear 553b that are adjacent to each other is varied by the rotation thereof, the second magnetic gears 553b are rotated along the rotating direction R2, thereby forcing the first pivot part 522 and the second pivot parts 532 to be rotated along the rotating direction R2. In this way, the first mounting part 521b and the second mounting parts 531b are rotated along the rotating direction R2 relative to the fixed bracket 510, thereby allowing the image capturing device 561 and the light emitting components 562 to swing along Z-axis.

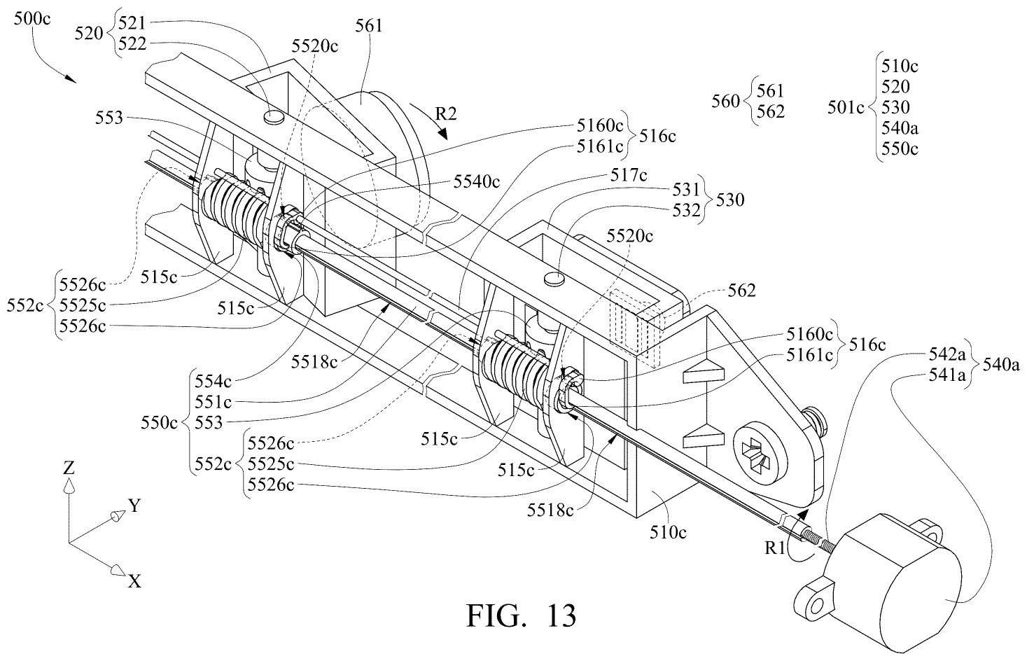

The disclosure is not limited to allowing the image capturing device and all of the light emitting components to swing together. Please refer to FIG. 13 that is a perspective view showing that a first movable bracket 520 of an adjustable monitoring device 500c of a fourth embodiment of the disclosure swings. In this embodiment, the adjustable monitoring device 500c includes an adjusting assembly 501c and the image capturing assembly 560. In this embodiment, the adjusting assembly 501c includes a fixed bracket 510c, the first movable bracket 520, the second movable brackets 530, a driving component 540a and a connecting structure 550c.

The fixed bracket 510c has a plurality of supporting plates 515c and a plurality of pushing elastic arms 516c. Each pushing elastic arm 516c includes a fixed end part 5160c and a movable end part 5161c that are connected to each other. The fixed end part 5160c of each pushing elastic arm 516c is fixed to a side of one supporting plate 515c. In addition, in this embodiment, the adjustable monitoring device 500c may further include a connecting component 517c. The connecting component 517c is rotatably disposed on the supporting plates 515c and is, for example, a rod. The connecting component 517c is fixed to a side of the movable end part 5161c of each pushing elastic arm 516c that is located close to the fixed end part 5160c. The connecting structure 550c includes a connecting rod 551c, a plurality of first gears 552c, a plurality of second gears 553 and a shift component 554c. The connecting rod 551c is disposed through the first gears 552c, and has an engagement recess 5518c. The movable end parts 5161c of the pushing elastic arms 516c are removably engaged with the engagement recess 5518c, so as to restrict the rotation of the connecting rod 551c along X-axis direction. The first gear 552c includes a teeth part 5525c and two mounting parts 5526c. The two mounting parts 5526c are connected to two opposite ends of the teeth part 5525c, respectively. The two mounting parts 5526c are rotatably disposed on two adjacent supporting plates 515c, respectively, so as to allow the first gears 552c to be supported by the supporting plate 515c. The second gears 553 are sleeved on the first pivot part 522 and the second pivot parts 532, respectively. The second gears 553 are engaged with the first gears 552c, respectively. The shift component 554c is sleeved on the connecting rod 551c. The connecting rod 551c is connected to the driving component 540a. Each first gear 552c has a first engagement structure 5520c. The shift component 554c has a second engagement structure 5540c. The first engagement structure 5520c and the second engagement structure 5540c are, for example, a recess and a protrusion matched with each other, respectively. The second engagement structure 5540c is configured to be engaged with one of the first engagement structures 5520c.

Hereinafter, it is exemplarily illustrated that the light emitting components 562 swing along Z-axis in a separate or independent manner with the help of the connecting structure 550b. However, the disclosure is not limited thereto. Although the image capturing device and the first movable bracket are omitted from the drawings for the illustration, the image capturing device and one or more light emitting components 562 may swing along Z-axis in a separate or independent manner with the help of the connecting structure 550b.

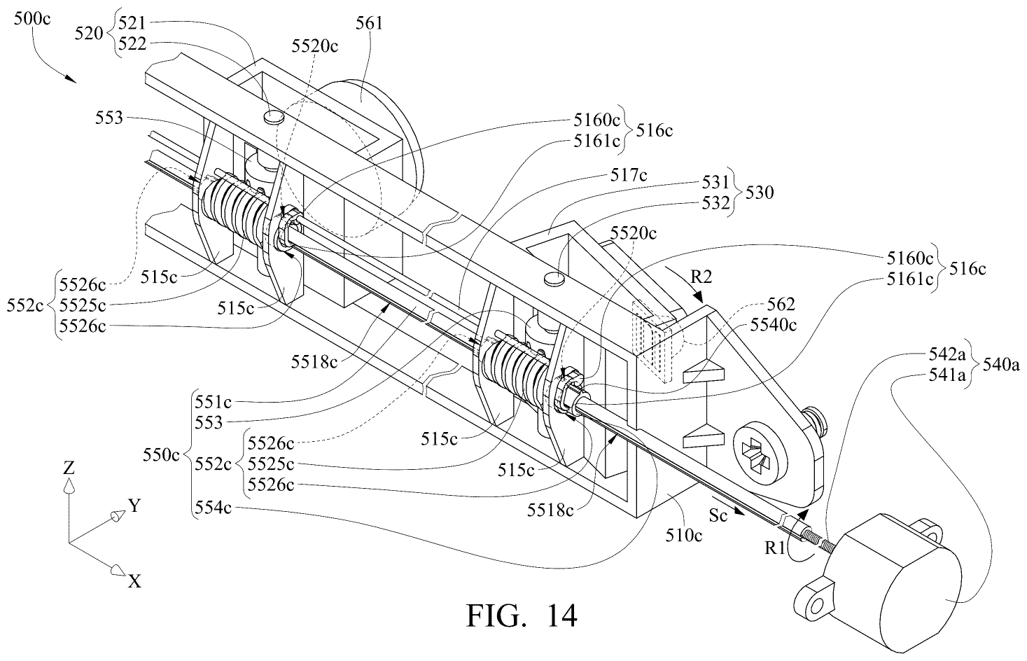

Please refer to FIGS. 13 and 14. FIG. 14 is a perspective view showing that the second movable bracket 530 of the adjustable monitoring device 500c in FIG. 13 swings. As shown in FIG. 13, when the second engagement structure 5540c is engaged with one of the first engagement structures 5520c, the shift component 554c pushes the movable end part 5161c of the adjacent pushing elastic arm 516c, so as to remove the movable end parts 5161c of all the pushing elastic arms 516c from the engagement recess 5518c of the connecting rod 551c with the help of the connecting component 517c. In this way, the driving component 540a is allowed to rotate the connecting rod 551c along the rotating direction R1, so as to force the shift component 554c to allow one first gear 552c engaged with the shift component 554c to be rotated along the rotating direction R1. Thus, the second gear 553c meshed with the one first gear 552c is rotated along the rotating direction R2. Further, the second gear 553c forces the first pivot part 522 on which the second gear 553c sleeved to be rotated along the rotating direction R2. Also, if the driving component 540a rotates the connecting rod 551c along a direction opposite to the rotating direction R1, the first pivot part 522 will be rotated along a direction opposite to the rotating direction R2, and the first pivot part 522 will be changed from the state shown in FIG. 13 back to the state shown in FIG. 14.

As shown in FIG. 14, the inner threaded structure of the connecting rod 551c is mated with the outer threaded structure of the shaft 542a, and the movable end parts 5161c of the pushing elastic arms 516c are removably engaged with the engagement recess 5518c to restrict the rotation of the connecting rod 551c along X-axis direction. Thus, the driving component 540a is configured to force the connecting rod 551c and the shift component 554c to slide along a sliding direction Sc together. When the second engagement structure 5540c is engaged with another one of the first engagement structures 5520c, the shift component 554c pushes the movable end part 5161c of the adjacent pushing elastic arm 516c, so as to remove the movable end parts 5161c of all the pushing elastic arms 516c from the engagement recess 5518c of the connecting rod 551c with the help of the connecting component 517c. In this way, the driving component 540a is allowed to rotate the connecting rod 551c along the rotating direction R1, so as to force the shift component 554c to allow another first gear 552c engaged with the shift component 554c to be rotated along the rotating direction R1. Thus, the second gear 553c meshed with the another first gear 552c is rotated along the rotating direction R2. Further, the second gear 553c forces the second pivot part 532 on which the second gear 553c sleeved to be rotated along the rotating direction R2. Note that a guiding means such as an inclined surface may be applied to facilitate the shift component 554c to remove movable end parts 5161c of the pushing elastic arms 516c from the engagement recess 5518c of the connecting rod 551c.

In one embodiment, the angle or range by which the first pivot part 522 and the second pivot part 532 are rotated may be adjusted by changing the time duration by which the driving component 540a rotates the connecting rod 551c and the shift component 554c. For example, the driving component 540a may rotate the shift component 554c and thus the first pivot part 522 may be rotated along the rotating direction R1 by a first time duration when the shift component 554c is engaged with the first gear 552c corresponding to the first pivot part 522; also, the driving component 540a may rotate the shift component 554c and thus the second pivot part 532 may be rotated along the rotating direction R1 by a second time duration when the shift component 554c is engaged with the first gear 552c corresponding to the second pivot part 532 (the driving component 540a does not rotate the first gear 552c corresponding to the first pivot part 522 in this scenario). If the first time duration is longer than the second time duration and the first and second pivot parts 522 and 532 are rotated along the same direction (e.g., the same rotating direction R1), the first pivot part 522 will be rotated by an angle (or range) that is larger than the angle (or range) by which the second pivot part 532 is rotated.

Moreover, before the second engagement structure 5540c is engaged with the first engagement structure 5520c, the driving component 540a may rotate the shift component 554c so as to align the second engagement structure 5540c with the first engagement structure 5520c.

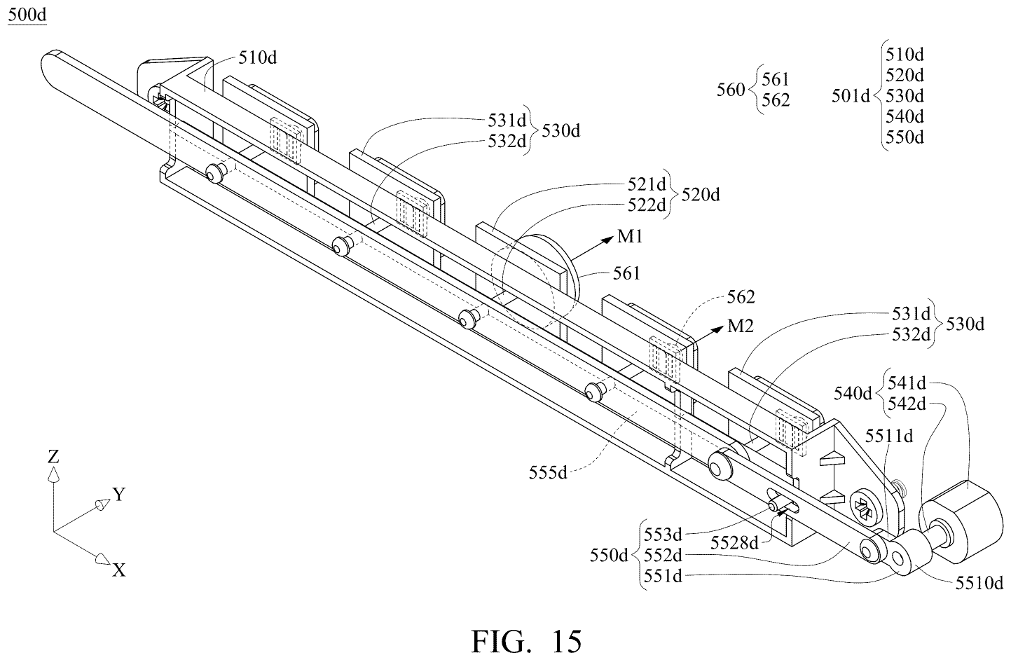

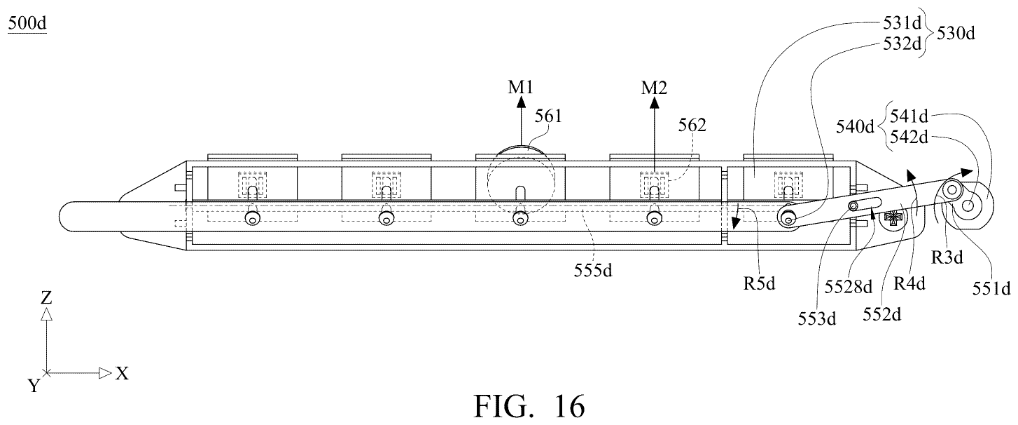

Additionally, the disclosure is not limited by the direction along which the image capturing device and the light emitting component swing. Please refer to FIGS. 15 and 16. FIG. 15 is a perspective view of an adjustable monitoring device 500d according to a fifth embodiment of the disclosure. FIG. 16 is a rear view showing that the adjustable monitoring device 500d in FIG. 15 swings. In this embodiment, the adjustable monitoring device 500d includes an adjusting assembly 501d and the image capturing assembly 560. In this embodiment, the adjusting assembly 501d includes a fixed bracket 510d, a first movable bracket 520d, a plurality of second movable brackets 530d, a driving component 540d and a connecting structure 550d.

The first movable bracket 520d includes a first mounting part 521d and a first pivot part 522d. The first mounting part 521d is fixed to the first pivot part 522d. The first pivot part 522d is rotatably disposed on the fixed bracket 510d.

Each second movable bracket 530d includes a second mounting part 531d and a second pivot part 532d. The second mounting part 531d is fixed to the second pivot part 532d. The second pivot part 532d is rotatably disposed on the fixed bracket 510d. The first pivot part 522d and the second pivot parts 532d are connected to one another by, for example, a connecting rod 555d.

For example, the driving component 540d is a motor and includes a main body 541d and a shaft 542d connected to each other. The connecting structure 550d includes a first link 551d, a second link 552d and a pivot 553d. The first link 551d has a fixed end 5510d and a pivoted end 5511d opposite to each other. Two opposite ends of the second link 552d are pivotally connected to the pivoted end 5511d of the first link 551d and the second pivot part 532d, respectively. The second link 552d has a sliding groove 5528d. The second link 552d is pivotally connected to the fixed bracket 510d via the pivot 553d, and the pivot 553d is slidably disposed in the sliding groove 5528d. The fixed end 5510d is fixed to the shaft 542d of the driving component 540d.

Also, in this embodiment, an axial direction (i.e., Y-axis direction) of the first pivot part 522d and the second pivot part 532d is parallel to the image monitoring directions M1 and M2.

Please refer to FIGS. 15 and 16. The shaft 542d of the driving component 540d is configured to be rotated along a rotating direction R3d, so as to force the second link 552d to be rotated along a rotating direction R4d via the first link 551d and force the pivot 553d to slide in the sliding groove 5528d. Thus, the second link 552d forces one second pivot part 532d to be rotated along a rotating direction R5d. In this way, the one second pivot part 532d forces other second pivot parts 532d and the first pivot part 522d to be rotated along the rotating direction R5d via the connecting rod 555d, thereby allowing the image capturing device 561 and the light emitting components 562 to swing upwards or downwards along X-axis.

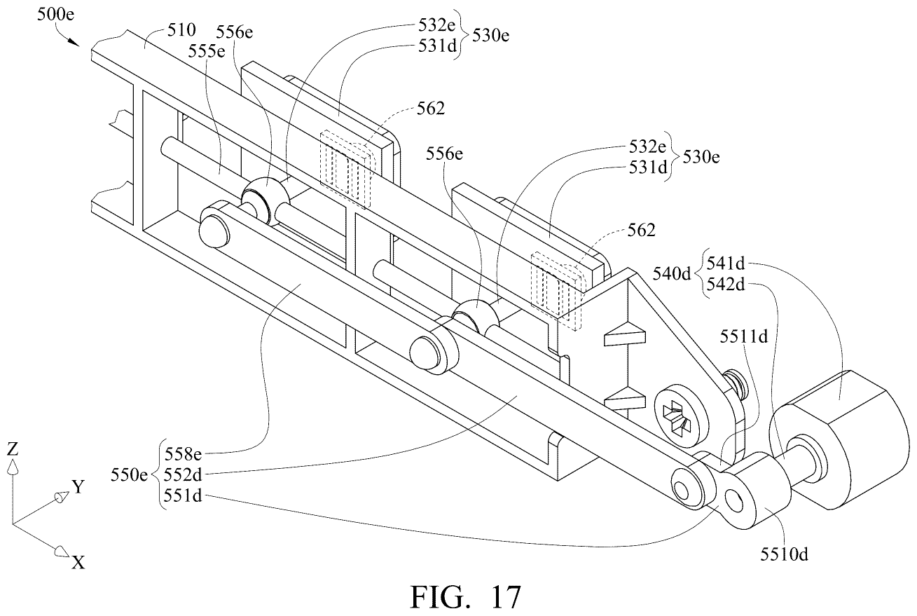

Alternatively, please refer to FIG. 17 that is a partially enlarged perspective view of an adjustable monitoring device 500e according to a sixth embodiment of the disclosure. The difference between the adjustable monitoring device 500e of this embodiment and the adjustable monitoring device 500d of the fifth embodiment is the configurations of the first pivot part, the second pivot part and the connecting structure. In this embodiment, for example, the second pivot part 532e of the second movable bracket 530e is a ball pivot and is rotatably disposed on the connecting rod 555e via a ball bearing 556e.

The connecting structure 550e includes the first link 551d, the second link 552d and a third link 558e. Two opposite ends of the third link 558e are pivotally connected to adjacent two second pivot parts 532e, respectively.

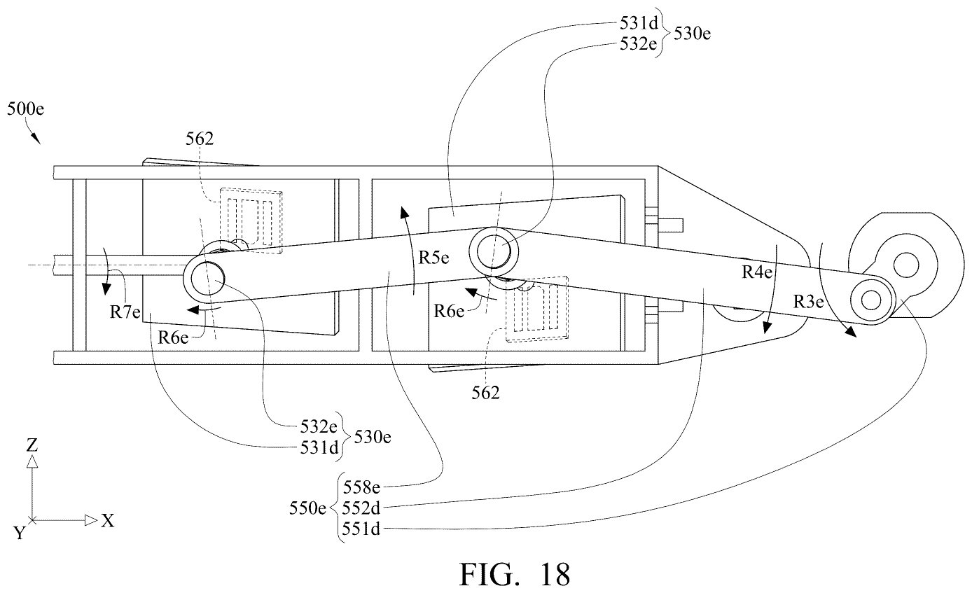

Please refer to FIGS. 17 and 18. FIG. 18 is a rear view showing that the adjustable monitoring device 500e in FIG. 17 swings. The shaft 542d of the driving component 540d are configured to be rotated along a rotating direction R3e, so as to force the second link 552d to be rotated along a rotating direction R4e via the first link 551d. Thus, the second link 552d forces the second pivot part 532e to be rotated along both of a rotating direction R5e and a rotating direction R6e. Meanwhile, the third link 558e forces another adjacent second pivot part 532e to be rotated along both of a rotating direction Re opposite to the rotating direction R5e and the rotating direction R6e. In this way, the second mounting part 531d and the light emitting component 562 swing leftwards or rightwards along Z-axis and swing upwards or downwards along X-axis. Note that in this embodiment, for example, the connecting structure 550e, the connecting rod 555e and the ball bearing 556e are used to force two adjacent second mounting parts 531d to swing leftwards or rightwards and swing upwards or downwards. However, the disclosure is not limited thereto. In other embodiments, although not shown, the first pivot part of the first movable bracket may be a ball pivot and may be rotatably disposed on the connecting rod via a ball bearing. In such embodiments, the first pivot part and the second pivot part may be located adjacent to each other, and the connecting structure, the connecting rod and the ball bearing may be used to force the first pivot part and the second pivot part that are adjacent to each other to swing leftwards or rightwards and swing upwards or downwards.

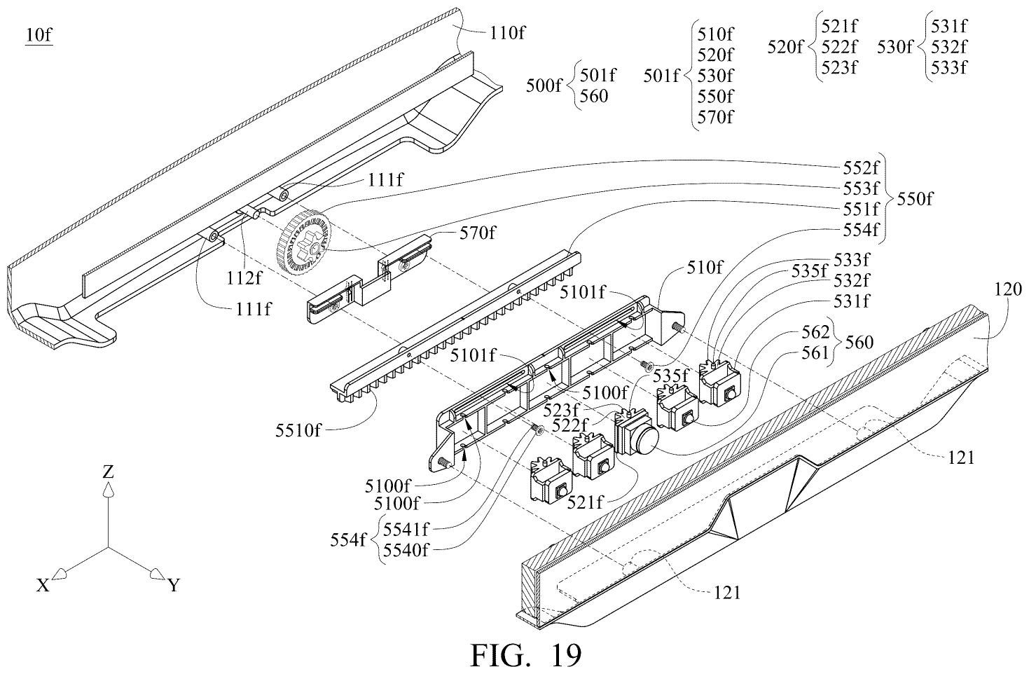

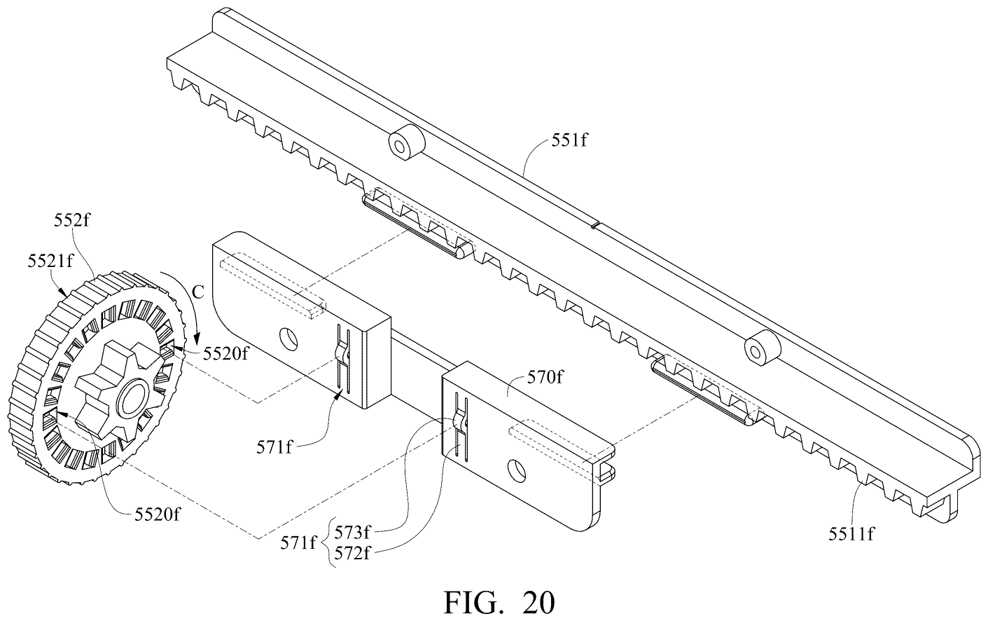

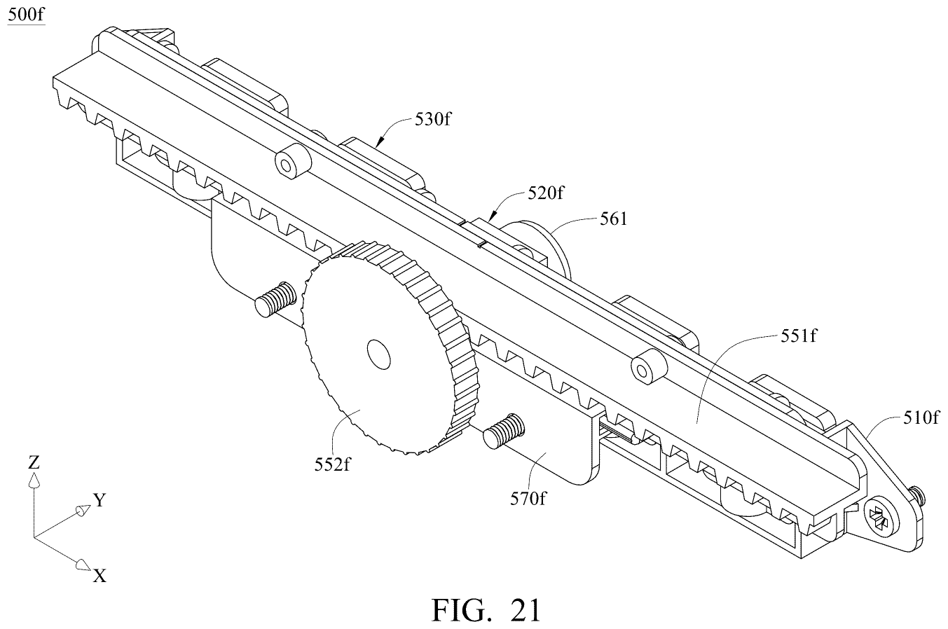

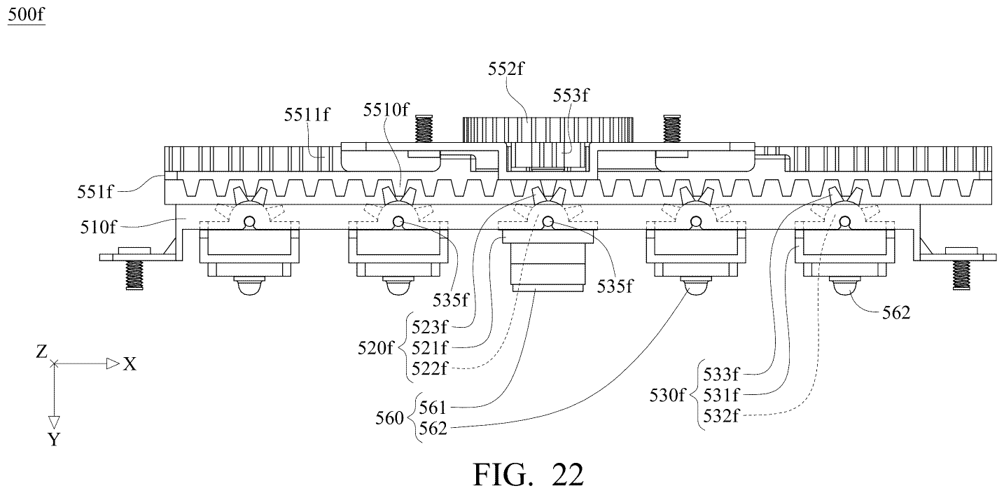

The adjusting assembly of the disclosure is not limited to including the driving component. Please refer to FIGS. 19 to 22. FIG. 19 is a partially enlarged exploded view of an electronic assembly 10f according to a seventh embodiment of the disclosure. FIG. 20 is a partial exploded view of the electronic assembly 10f in FIG. 19. FIG. 21 is a perspective view of an adjustable monitoring device 500f of the electronic assembly 10f in FIG. 19. FIG. 22 is a top view of the adjustable monitoring device 500f in FIG. 21.

In this embodiment, the electronic assembly 10f includes a housing 100f and an adjustable monitoring device 500f. Note that the electronic assembly 10f may include the transparent panel 200, the image displaying component 300 and the motherboard 400 in FIG. 2. The housing 100 includes, for example, a base 110f and the front frame 120.

In this embodiment, the adjustable monitoring device 500f is disposed in the housing 100f and includes an adjusting assembly 501f and the image capturing assembly 560. In this embodiment, the adjusting assembly 501f includes a fixed bracket 510f, a first movable bracket 520f, a plurality of second movable brackets 530f, a connecting structure 550f and a mounting bracket 570f.

The fixed bracket 510f is fixed to the two fixing pins 121 of the front frame 120 via, for example, screwing. The first movable bracket 520f includes a first mounting part 521f, a first pivot part 522f and a teeth part 523f. The first mounting part 521f is fixed to the first pivot part 522f. The teeth part 523f protrudes from a side of the first pivot part 522f located away from the first mounting part 521f. The first pivot part 522f is rotatably disposed on the fixed bracket 510f.

Each second movable bracket 530f includes a second mounting part 531f, a second pivot part 532f and a teeth part 533f. The second mounting part 531f is fixed to the second pivot part 532f. The teeth part 533f protrudes from a side of the second pivot part 532f located away from the second mounting part 531f. The second pivot part 532f is rotatably disposed on the fixed bracket 510f.

In this embodiment, the fixed bracket 510f has a plurality of first engagement structures 5100f, and each of the first mounting part 521f and the second mounting part 531f have a second engagement structure 535f located on both sides thereof. The first engagement structure 5100f and the second engagement structure 535f are, for example, a recess and a protrusion matched with each other, respectively. The first engagement structure 5100f and the second engagement structure 535f are engaged with each other.

The connecting structure 550f includes, for example, a gear rack 551f, a handheld wheel 552f, a gear 553f and two restricting screws 554f. The gear rack 551f is slidably disposed on the base 110f. The gear rack 551f has a first rack teeth part 5510f and a second rack teeth part 5511f. The first rack teeth part 5510f and the second rack teeth part 5511f are located on two opposite sides of the gear rack 551f, respectively. The first rack teeth part 5510f is meshed with the teeth parts 523f and 533f. The second rack teeth part 5511f is meshed with the gear 553f. The gear 553f protrudes from a side of the handheld wheel 552f, and is located between the handheld wheel 552f and the gear rack 551f. The handheld wheel 552f is rotatably disposed on the base 110f via a pivot 112f.

The two restricting screws 554f each include a head part 5540f and a body part 5541f connected to each other. The fixed bracket 510f has two sliding grooves 5101f. The two body parts 5541f are slidably disposed in the two sliding grooves 5101f, respectively, and are fixed to the gear rack 551f. A part of the fixed bracket 510f is clamped between the head parts 5540f and the gear rack 551f, so as to restrict the movement of the gear rack 551f.

The mounting bracket 570f is fixed to two fixing pins 111f of the base 110f via, for example, screwing. The gear rack 551f is slidably disposed on the mounting bracket 570f.

In this embodiment, the handheld wheel 552f has a plurality of first positioning structures 5520f. The first positioning structures 5520f are arranged along a circumferential direction C of the handheld wheel 552f, and are, for example, positioning recesses. The mounting bracket 570f has two second positioning structures 571f. The second positioning structures 571f each include, for example, an elastic plate 572f and a positioning protrusion 573f located on the elastic plate 572f. The two positioning protrusions 573f are positioned in two of the first positioning structures 5520f, respectively.

In addition, the handheld wheel 552f has, for example, an anti-slip structure 5521f to allow the handheld wheel 552f to be firmly held.

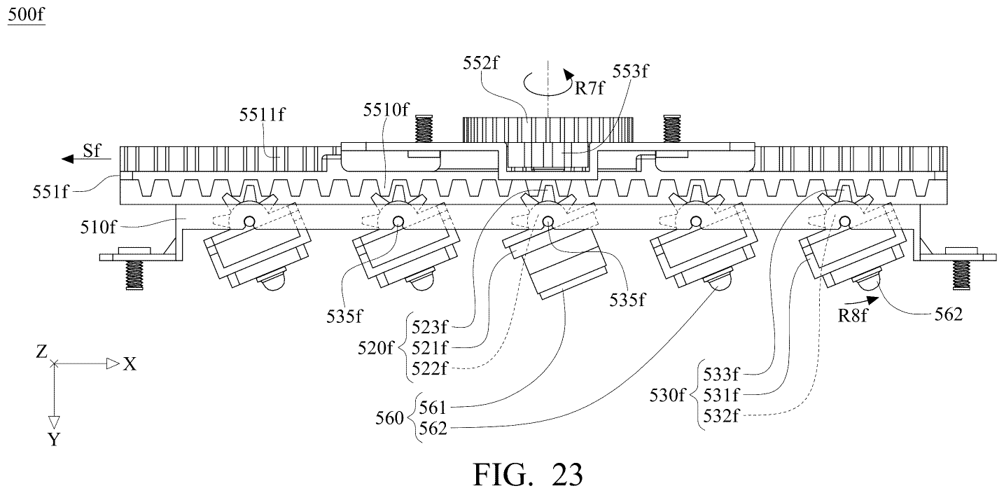

Please refer to FIGS. 22 and 23. FIG. 23 is a top view showing that the adjustable monitoring device 500e in FIG. 22 swings. The handheld wheel 552f may be manually rotated along a rotating direction R7f, so as to force the gear rack 551f to slide along a sliding direction Sf. Thus, the gear rack 551f forces the teeth parts 523f and 533f to be rotated along a rotating direction R8f, thereby forcing the first mounting part 521f and the second mounting parts 531f to be rotated along the rotating direction R8f via the first pivot part 522f and the second pivot parts 532f. In this way, the image capturing device 561 and the light emitting components 562 swing along Z-axis.

Note that in other embodiments, the handheld wheel 552f, the gear 553f and the mounting bracket 570f may be omitted, and a driving component such as a motor may be used to drive the gear rack.

According to the adjustable monitoring device and the electronic assembly disclosed by above embodiments, the first movable bracket and the second movable bracket are configured to swing relative to the fixed bracket so as to adjust the image monitoring direction of the image capturing assembly. Thus, since the first movable bracket and the second movable bracket are able to swing, the image capturing device is allowed to capture images at different angles. In this way, even though the driver moves, the image monitoring direction of the image capturing device is allowed to be adjusted according to the movement of the driver. Thus, the image capturing device is able to effectively monitor the attentiveness of the driver.

Also, when the adjustable monitoring device is applied to, for example, a car, the image capturing assembly is allowed to capture images at desired angles regardless of the right-hand drive car or the left-hand drive car since the image capturing assembly is able to swing together with the first movable bracket or the second movable bracket. That is, the adjustable monitoring device is allowed to be shared among cars of different types, thereby significantly reducing the cost for developing exclusive monitoring device for a specific type of car.

Note that the adjustable monitoring device according to the disclosure is applied to, for example, a rearview mirror in a cockpit of the car, but the disclosure is not limited thereto. The adjustable monitoring device according to the disclosure may be mounted on a dashboard, a car chassis or a car frame, and may be mounted in a cockpit of any type of vehicle such as a boat, a ship, and an airplane.

Alternatively, in another application, the adjustable monitoring device may be used to monitor the outside environment of the car. Specifically, the adjustable monitoring device according to the disclosure may be mounted on the outer side of the car to monitor the outside environment of the car, such as being mounted on the outer rearview mirror or the top of the car.

Alternatively, the adjustable monitoring device according to the disclosure may be mounted on a motorcycle, a bike or a bicycle.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. An adjustable monitoring device, comprising:
an adjusting assembly, comprising a fixed bracket, a first movable bracket and a second movable bracket, wherein the first movable bracket and the second movable bracket are movably disposed on the fixed bracket, and the second movable bracket is spaced apart from the first movable bracket; and
an image capturing assembly, connected to the adjusting assembly, wherein an image monitoring direction of the image capturing assembly is adjustable by the adjusting assembly.

2. The adjustable monitoring device according to claim 1, wherein the image capturing assembly comprises an image capturing device, the first movable bracket comprises a first mounting part and a first pivot part, the first mounting part is fixed to the first pivot part, the first pivot part is rotatably disposed on the fixed bracket, and the image capturing device is fixed to a side of the first mounting part located away from the first pivot part.

3. The adjustable monitoring device according to claim 2, wherein the adjusting assembly further comprises a driving component and a connecting structure, and the connecting structure connects the driving component and the first pivot part.

4. The adjustable monitoring device according to claim 3, wherein the connecting structure comprises a connecting rod, a first gear and a second gear, the first gear is sleeved on the connecting rod, the second gear is sleeved on the first pivot part and is meshed with the first gear, and the connecting rod is connected to the driving component.

5. The adjustable monitoring device according to claim 3, wherein the image capturing assembly further comprises a light emitting component, the second movable bracket comprises a second mounting part and a second pivot part, the second mounting part is fixed to the second pivot part, the second pivot part is rotatably disposed on the fixed bracket, the light emitting component is fixed to a side of the second mounting part located away from the second pivot part, the connecting structure comprises a connecting rod, a plurality of first gears, a plurality of second gears and a shift component, the connecting rod is disposed through the plurality of first gears, the plurality of second gears are sleeved on the first pivot part and the second pivot part, respectively, the plurality of second gears are meshed with the plurality of first gears, respectively, the shift component is sleeved on the connecting rod, the connecting rod is connected to the driving component, the plurality of first gears each have a first engagement structure, the shift component has a second engagement structure, and the second engagement structure is engaged with one of the first engagement structures.

6. The adjustable monitoring device according to claim 3, wherein the first movable bracket further comprises a pushed protrusion, the pushed protrusion protrudes from a side of the first pivot part located away from the first mounting part, the connecting structure comprises a connecting rod, a first pushing protrusion and a second pushing protrusion, the first pushing protrusion and the second pushing protrusion radially protrude from the connecting rod, the pushed protrusion is located between the first pushing protrusion and the second pushing protrusion, the connecting rod is slidably disposed on a shaft of the driving component.

7. The adjustable monitoring device according to claim 3, wherein the connecting structure comprises a connecting rod, a first magnetic gear and a second magnetic gear, the first magnetic gear is sleeved on the connecting rod, the second magnetic gear is sleeved on the first pivot part and located adjacent to the first magnetic gear, an axial direction of the first magnetic gear is non-parallel to an axial direction of the second magnetic gear, and the connecting rod is connected to the driving component.

8. The adjustable monitoring device according to claim 3, wherein the connecting structure comprises a first link and a second link, the first link has a fixed end and a pivoted end opposite to each other, two opposite ends of the second link are pivotally connected to the pivoted end of the first link and the first pivot part, respectively, and the fixed end is fixed to a shaft of the driving component.

9. The adjustable monitoring device according to claim 8, wherein the first pivot part is a ball pivot.

10. The adjustable monitoring device according to claim 3, wherein the first movable bracket further comprises a teeth part, the teeth part protrudes from a side of the first pivot part located away from the first mounting part, the connecting structure comprises a gear rack, the gear rack is slidably disposed relative to the fixed bracket and has a first rack teeth part and a second rack teeth part, the first rack teeth part and the second rack teeth part are located on two opposite sides of the gear rack, respectively, and the first rack teeth part is meshed with the teeth part.

11. The adjustable monitoring device according to claim 10, further comprising a mounting bracket, wherein the connecting structure further comprises a handheld wheel and a gear, the gear protrudes from a side of the handheld wheel and is located between the handheld wheel and the gear rack, the handheld wheel is rotatably disposed relative to the mounting bracket, the gear rack is slidably disposed on the mounting bracket, and the second rack teeth part is meshed with the gear.

12. The adjustable monitoring device according to claim 11, wherein the handheld wheel has a plurality of first positioning structures, the plurality of first positioning structures are arranged along a circumferential direction of the handheld wheel, the mounting bracket has a second positioning structure, and the second positioning structure is positioned with one of the plurality of first positioning structures.

13. The adjustable monitoring device according to claim 10, wherein the connecting structure further comprises a restricting screw, the restricting screw comprises a head part and a body part connected to each other, the fixed bracket has a sliding groove, the body part is slidably disposed in the sliding groove and fixed to the gear rack, and a part of the fixed bracket is clamped between the head part and the gear rack.

14. The adjustable monitoring device according to claim 10, wherein the fixed bracket has a first engagement structure, and the first mounting part has a second engagement structure, and the first engagement structure is engaged with the second engagement structure.

15. The adjustable monitoring device according to claim 2, wherein an axial direction of the first pivot part is perpendicular to the image monitoring direction of the image capturing device.

16. The adjustable monitoring device according to claim 2, wherein an axial direction of the first pivot part is parallel to the image monitoring direction of the image capturing device.

17. An electronic assembly, comprising:
a housing;
an image displaying component, disposed in the housing; and
an adjustable monitoring device, disposed in the housing and comprising:
an adjusting assembly, comprising a fixed bracket, a first movable bracket and a second movable bracket, wherein the first movable bracket and the second movable bracket are movably disposed on the fixed bracket, and the second movable bracket is spaced apart from the first movable bracket; and
an image capturing assembly, connected to the adjusting assembly, wherein an image monitoring direction of the image capturing assembly is adjustable by the adjusting assembly.

18. The electronic assembly according to claim 17, wherein the image capturing assembly comprises an image capturing device, the first movable bracket comprises a first mounting part and a first pivot part, the first mounting part is fixed to the first pivot part, the first pivot part is rotatably disposed on the fixed bracket, and the image capturing device is fixed to a side of the first mounting part located away from the first pivot part.

19. The electronic assembly according to claim 18, wherein the adjusting assembly further comprises a driving component and a connecting structure, and the connecting structure connects the driving component and the first pivot part.

20. The electronic assembly according to claim 19, wherein the connecting structure comprises a connecting rod, a first gear and a second gear, the first gear is sleeved on the connecting rod, and the second gear is sleeved on the first pivot part and is meshed with the first gear.
